(19) United States
(12) Patent Application Publication
(10) Pub. No.: US 2018/0058932 A1
(43) Pub. Date: Mar. 1, 2018

(54) METHOD FOR ANALYZING THE TYPES OF WATER SOURCES BASED ON NATURAL GEOGRAPHICAL FEATURES

(71) Applicant: China Institute of Water Resources and Hydropower Research, Beijing (CN)

(72) Inventors: Denghua YAN, Beijing (CN); Boya GONG, Beijing (CN); Wanli SHI, Beijing (CN); Baisha WENG, Beijing (CN); Tianling QIN, Beijing (CN); Hao WANG, Beijing (CN)

(73) Assignee: China Institute of Water Resources and Hydropower Research, Beijing (CN)

(21) Appl. No.: 15/655,890

(22) Filed: Jul. 21, 2017

(30) Foreign Application Priority Data
Aug. 12, 2016 (CN) 2016106644336

(51) Int. Cl. G01J 3/28; G06K 9/62; G06K 9/78; G06K 9/20

(52) U.S. Cl. CPC G01J 3/2823; G06K 9/628; G01J 2003/283; G06K 9/209; G06K 9/78

(57) ABSTRACT

A method for analyzing types of water sources based on natural geographical feature, the method includes: collecting and processing remote sensing image data of target area, and obtaining maximum and minimum value of an annual vegetation index; subtracting the minimum value from the maximum value to obtain maximum variation range of annual vegetation index; extracting topography factors from a digital elevation model in target area; obtaining a natural vegetation area in target area; carrying out a normalization processing for the maximum variation range and the topography factors in this natural regions, and obtaining landform zones and situation of plant growth of different zones in the natural vegetation area by spatial cluster analysis in ArcGIS; obtaining a precipitation of landform zones in the growing season and the distances between the landform zones and the water sources, and obtaining the zones for the types of water sources based on natural geographical features.

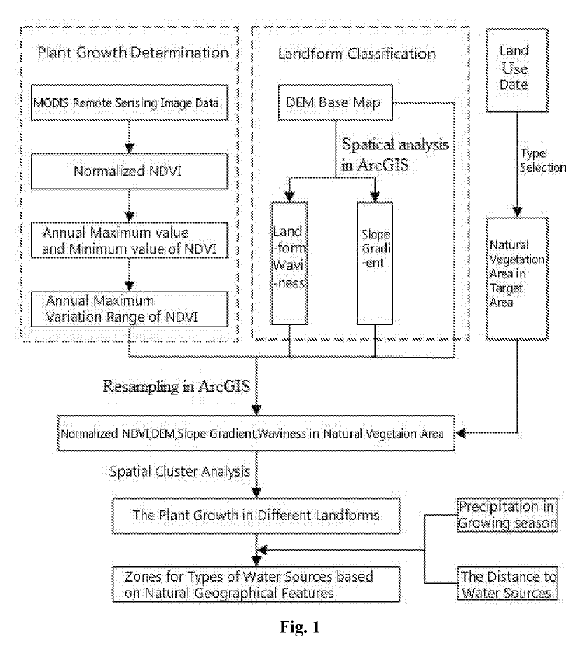

### CROSS REFERENCE TO RELATED APPLICATIONS

This application is based upon and claims priority to Chinese Patent Application No. 2016106644336 (CN) filed on Aug. 12, 2016, the entire contents of which are incorporated herein by reference.

### TECHNICAL FIELD

The present invention particularly relates to a method for analyzing the types of water sources based on natural geographical features.

### BACKGROUND OF THE INVENTION

The characteristics of water sources in different geographical units are comprehensively affected by regional precipitation characteristics (i.e. a phase of matter and a composition thereof, rainfall pattern, rainfall intensity, spatial and temporal distribution), conditions of land surface (i.e. vegetation, soil and aquifer consortium), energy process, spatial hydraulic connection, and the developments of water and soil resources by the human being. Under the influences of climate change and human activities, different geographical units have different constituents of water sources and mechanisms of evolution, and have obvious multi-scale spatial and temporal characteristics. The scientific water source analysis is not only a basis of recognizing the runoff inconsistency and unsteady characteristics of water resource system, but also a key basis to carry out targeted and accurate multi-objective control of water resources, which is one of the leading and hot issues on the international hydrology and water resource management.

Currently, with respect to the analysis of water sources, from the perspective of “water budgets and balances”, a great amount of work has been carried out at home and abroad for analyzing the types and constituents of water sources by comprehensively using technical solutions such as tracer and simulation. However, the types and constituents of water sources have basic characteristic drawbacks, namely “three-more and three-less”, which is as follows: firstly, “more watercourses and less slopes”, namely more work for analyzing the water sources of different rivers or transection of reservoirs, but less studies for analyzing the constituents of water sources of different slope units; secondly, “more states and less processes”, namely more studies for certain periods or certain time nodes, but less work for the evolution process of important types of water sources and the comprehensive influence for water circulation thereof; thirdly, “more analyses and less examinations”, namely more work for analyzing the constituents of water sources by a single method, but less studies for examining the scientificity and reliability of analyzing result by multiple methods. Additionally, the high-altitude areas (e.g. Qinghai-Tibet Plateau etc.), subjected to data and scientific work conditions, have less related researches.

### SUMMARY OF THE INVENTION

Regarding the drawbacks of the prior art, the present invention provides a method for analyzing the types of water sources based on natural geographical features. The types of the water sources for the target area are comprehensively zoned by a spatial cluster analysis method with reference to the regional natural geographical features, such that the practical demands of the ecological barrier construction, water resource protection and the responses to climate change are satisfied.

To achieve the above inventive objectives, the technical solutions adopted by the present invention are as below: a method for analyzing the types of water sources based on natural geographical features is provided, and the method includes the following steps:
i. S1: collecting remote sensing image data of a target area, processing the remote sensing image data, and obtaining a maximum value and a minimum value of an annual vegetation index;
ii. S2: subtracting the minimum value from the maximum value of the annual vegetation index to obtain a maximum variation range of the annual vegetation index;
iii. S3: extracting the topography factors correlated to the landform classifications from digital elevation model data in the target area;
iv. S4: obtaining a natural vegetation area in the target area;
v. S5: carrying out a normalization processing for the maximum variation range of the annual vegetation index and the topography factors in the natural vegetation area, and obtaining landform zones and situation of plant growth of different zones in the natural area by technologies of ArcGIS spatial cluster analysis and spatial analysis;
vi. S6: obtaining a precipitation of landform zones in a growing season and a distance between the landform zones and the water sources;
vii. S7: analyzing types of water supplies of the zones with reference to the precipitation of landform zones in the growing season and the distance between the landform zones and the water sources, obtaining the zones for the types of water sources based on natural geographical features.

Furthermore, in S1, the remote sensing image data of the target area is collected by a moderate-resolution imaging spectroradiometer.

Furthermore, the specific process of step S1 is as below: processing the remote sensing image data by the remote sensing image processing, interpreting the processing result quantitatively to obtain a target area layer with information of a vegetation index, obtaining the maximum value and the minimum value of the annual vegetation index by a raster calculator of ArcGIS in combination with a Python program.

Furthermore, the specific process of step S3 is as below: with the digital elevation model used as the data source, resampling in ArcGIS to obtain raster data with the same data projection and resolution as the vegetation index and generating a raster layer of topography factors according to the digital elevation model by using a Spatial Analysis tool in ArcGIS.

Furthermore, the topography factors include a slope gradient and a topographic relief amplitude.

Furthermore, the specific process of step S4 is as below: analyzing a land use map of the target area in ArcGIS, obtaining a natural vegetation area in the target area with the permanent glacier and snow field, canal, lake, urban land, the rural resident area, sandy land, Gobi, bare land, and bare rock and gravel land removed.

Furthermore, in S5, when the normalization processing is employed to process the vegetation index and the raster layer of the topography factors of the natural vegetation area by a linear function, a raster value is mapped within a range of 0-1, a conversion formula of the linear function is:

$$Y = \frac{X - {X}_{min}}{{X}_{max} - {X}_{min}}$$

where X indicates the raster value before the conversion, Xₘₐₓ indicates a maximum raster value in a certain clustering factor raster layer within the target area; Xₘᵢₙ indicates a minimum raster value in a certain clustering factor raster layer within the target area; Y indicates a converted raster value.

Furthermore, the specific process of step S6 is as below: with TRMM data in the landform zones used as a data source, resampling is done in ArcGIS, obtaining raster data with the same data projection and resolution of the vegetation index and having a temporal resolution of one-day; obtaining the raster data of the precipitation of the landform zones in the growing season by the technologies of ArcGIS and Python program.

Furthermore, in S7, analyzing the types of water supplies in the zones with reference to the multi-year average precipitations of the landform zones in the growing season and the distances between the landform zones and rivers, lakes, glaciers etc., wherein a region that has a higher altitude, a better plant growth, and is more close to the glaciers is zoned as a supply of glacial snowmelt water and precipitation; the region that is farther from the water sources, has smaller topographic relief amplitude and lowered altitude is zoned as a supply of groundwater; the region that has more precipitations in the growing season is zoned as a supply of precipitation.

Furthermore, specific process of step S7 is as below: with reference to the analysis of topography and hydrology, classifying the types of water supplies of the landform zones as a supply by glacial snowmelt water, a supply by precipitation, a supply by precipitation and soil water, a supply by precipitation and groundwater outcropping, a supply by flood, lateral seepage of groundwater, and precipitation, a supply by precipitation, soil water, and groundwater outcropping; and obtaining the zones for the types of the water sources based on natural geographical features by providing a spatial distribution map for the types of water sources according to the types of water supplies.

The advantages of the present invention are as below: The method for analyzing the types of water sources based on natural geographical features, processes the maximum variation range of the annual vegetation index and the topography factors, to analyze and obtain the landform zones and the situations of plant growth of different zones in the natural vegetation area. Meanwhile, with reference to the precipitation of landform zones in the growing season and the distance between the landform zones and water sources, the types of water supplies are analyzed and the zones for the types of water sources based on natural geographical features are obtained. The types of water sources of the target area are comprehensively zoned by the method of spatial cluster analysis according to the regional natural geographical features. The innovations for classifying and zoning the groups of water sources can make a breakthrough in the conventional mode of “more watercourses and less slopes”, and satisfy the practical demands of the ecological barrier construction, water resource protection and the response to climate changes.

### BRIEF DESCRIPTION OF THE DRAWINGS

FIGURE is a schematic diagram of the method for analyzing the types of water sources based on natural geographical features.

### DETAILED DESCRIPTION OF THE INVENTION

Hereinafter, the technical solution in an embodiment of the present invention is clearly and fully described with reference to the drawings in the embodiment of the present invention. Apparently, the described embodiment is only one embodiment of the present invention. Based on the embodiment of the present invention, all the other embodiments that can be obtained without any creative efforts of those of ordinary skill in the art fall into the protection scope of the present invention.

For simplicity, things known to those of ordinary skill in the art are omitted in the following contents.

As shown in FIGURE, the method for analyzing the types of water sources based on natural geographical features includes following steps:
i. S1: collecting remote sensing image data of a target area, processing the remote sensing image data, and obtaining a maximum value and a minimum value of an annual vegetation index; in a specific implementation, the remote sensing image data of the target area is collected by a moderate-resolution imaging spectroradiometer.

S2: subtracting the minimum value from the maximum value of the annual vegetation index to obtain a maximum variation range of the annual vegetation index; in a specific implementation, a remote sensing image processing and Python programming are used for registration and correction, noise reduction and quality enhancement, data fusion, projection conversion, and data resampling. After that, a target area layer having the information of vegetation index is obtained by employing a quantitative interpretation;
i. The maximum value and minimum value of the annual vegetation index for each year are obtained as a maximum variation range of an annual vegetation index for each year using a raster calculator in ArcGIS and Python program. The multi-year average maximum variation range of the annual vegetation index for each year is computed as the average of the maximum variation range of the annual vegetation index for multiple years, wherein the growth of the vegetation is determined by the annual vegetation index, i.e. the bigger the maximum variation range of the annual vegetation index, the better is the growth of the vegetation.

S3: extracting topography factors correlated to a landform classifications from digital elevation model data in the target area; in a specific implementation, with the data from digital elevation model used as the data source, the raster data with the same data projection and resolution as the vegetation index is obtained by resampling in ArcGIS; then a topography factor raster layer is generated according to the digital elevation model by the Spatial Analysis tool in ArcGIS, wherein the topography factors include a slope gradient and a topographic relief amplitude.

S4: obtaining a natural vegetation area in the target area; in a specific implementation, with the integral land use data as a base map, a land use map of the target area is analyzed in ArcGIS, and with the permanent glacier and snow field, canal, lake, urban land, the rural resident area, sandy land, Gobi, bare land, and bare rock and gravel land removed, the natural vegetation area in the target area is obtained.

S5: carrying out a normalization processing for the maximum variation range of the annual vegetation index and the topography factors, obtaining landform zones in the natural vegetation area and a plant growth situation of different zones by technologies of spatial cluster analysis and a spatial analysis in ArcGIS; wherein the spatial cluster analysis of the vegetation and the topography factors is carried out based on the normalization processing for the maximum variation range of the annual vegetation index and the topography factors.

In a specific implementation, when the normalization processing is employed to process the vegetation index and topography factor raster layer of the natural vegetation area by a linear function, a raster value is mapped within a range of 0-1, a conversion formula of the linear function is:

$$Y = \frac{X - {X}_{min}}{{X}_{max} - {X}_{min}}$$

where X indicates a raster value before a conversion, Xₘₐₓ indicates a maximum raster value in a certain clustering factor raster layer within the target area; Xₘᵢₙ indicates a minimum raster value in a certain clustering factor raster layer within the target area; Y indicates a converted raster value.

S6: obtaining a precipitation of landform zones in a growing season and a distance between the landform zones and the water sources; in a specific implementation, with the TRMM data in the landform zones used as a data source, resampling is done in ArcGIS to obtain the raster data with the same data projection and resolution of the vegetation index and having a temporal resolution of one-day; the raster data of the precipitation of landform zones in the growing season is obtained by the technologies of ArcGIS and Python program.

S7: analyzing the types of water supplies of the zones, with reference to the precipitations of landform zones in the growing season and the distance between the landform zones and water sources, obtaining the zones for the types of water sources based on natural geographical features; in a specific implementation, the types of water supplies of the zones are analyzed with reference to the multi-year average precipitation of landform zones in the growing season and the distance between the landform zones and rivers, lakes, glaciers etc., and the zones for the types of the water sources based on natural geographical features are obtained and a spatial distribution map for the types of water sources is provided according to the types of water supplies.

For the practical analysis, the types of water sources in different regions are obtained based on the precipitations of different landform zones in the growing season and the conditions of the water sources in the zones; a region that has a higher altitude, a better plant growth, and is more close to the glaciers, is zoned as a supply of precipitation and glacial snowmelt water ; a region that is farther from the water sources, has smaller topographic relief amplitude and lower altitude is zoned as a supply of groundwater; a region that has more precipitations in the growing season is zoned as a supply of precipitation.

Further reference to the analysis of topography and hydrology, the types of water supplies of the landform zones are classified as: a supply by melting of snow of glaciers, a supply by precipitation, a supply by precipitation and soil water, a supply by precipitation and groundwater outcropping, a supply by flood, lateral seepage of groundwater, or different combinations thereof.

During the implementation, the method for analyzing types of water sources based on natural geographical features comprehensively zones the types of water sources for the target area by adopting the spatial cluster analysis, with reference to the regional natural geographical features. The innovations for classifying and zoning the groups of water sources make a breakthrough in the conventional mode of “more watercourses and less slope gradients”, and satisfy the demands of the ecological barrier construction, water resource protection and the response to climate changes.

As shown in FIGURE, the first embodiment of the present invention is provided:

the analysis for types of water sources of Naqu river basin in Tibet autonomous region of China based on the present invention which is as below:

1. The remote sensing image data of the Naqu river basin for a period ranging from 2000 to 2014 from the moderate resolution imaging spectroradiometer, having a resolution of 250 m*250 m, is selected as the data source. After the remote sensing image processing and Python programming are used for registration and correction, noise reduction and quality enhancement, data combination, projection and conversion, and data resampling, the raster data layer of Naqu river basin with the information of vegetation index is obtained by employing a quantitative interpretation. After that, in ArcGIS, with the Python programming, the maximum and minimum values of annual vegetation index of each raster unit for Naqu river basin are obtained for each year, and the minimum value is subtracted from the maximum value to obtain the maximum variation range of the annual vegetation index for each year and an average maximum variation range of the annual vegetation index for multiple years. It is supposed that, the larger the annual vegetation index varies, the better the plants grow, such that the plant growth of the vegetation can be determined by the annual vegetation index.

2. The data of the digital elevation model having resolution of 30 m*30 m from the

Naqu river basin, is selected as the data source. The resampling is carried out in the ArcGIS to obtain the raster data with the same data projection and resolution (i.e. 250 m*250 m) of the vegetation index; the layer of topography factors (i.e. slope gradient, topographic relief amplitude, etc.) is obtained according to the digital elevation model using Spatial Analysis tool in ArcGIS.

3. The TRMM data having a spatial resolution of 30 m*30 m and a temporal resolution of three hours from the Naqu river basin is selected as the data source. The resampling is carried out in the ArcGIS to obtain the raster data with the same data projection and spatial resolution (i.e. 250 m*250 m) of the vegetation index and having the temporal resolution of one day. Based on that, the raster data of multi-year average precipitation in the growing season (i.e. May to August) for Naqu river basin is computed using the technologies of ArcGIS and Python programming.

4. The land use data of Naqu river basin in the year of 2014 is used as the base map, and the layer of natural vegetation area for Naqu river basin is obtained by removing the types of land use in the ArcGIS, such as the permanent glacier and snow field, canal, lake, urban land, the rural resident area, sandy land, Gobi, bare land, and bare rock and gravel land etc.

5. The layer of the multi-year average maximum variation range of annual vegetation index, the slope gradient, the topographic relief amplitude, and the precipitation in the growing season are split based on the layer of natural vegetation area, and the data layer of the multi-year average maximum variation range of annual vegetation index, the topography factors, and the precipitation in the growing season are obtained.

6. The normalization processing is carried out for the raster data of the multi-year average maximum variation range of annual vegetation coverage index and the topography factors for the natural vegetation area, and cluster analysis is employed to obtain different landform zones and plant growth situation of the zones.

7. The sources of water supplies of the zones are analyzed based on the multi-year average precipitation of landform zones in the growing season and the distance between the landform zones and the rivers, the lakes, and the glacier. Based on above, the spatial distribution map of water sources for Naqu river basin is provided and the zones for the types of water sources based on natural geographical features are obtained.

In a specific implementation, during the spatial analysis for types of water sources, the types can be firstly classified, then followed by generating the indicators. Wherein the water supply types are classified by ArcGIS, and topographic factors including slope gradient, slope aspect, topographic relief amplitude can be generated from digital elevation model (DEM). Vegetation coverage rate is extracted by the moderate resolution image and the grassland distributions of high-coverage, mid-coverage, and low-coverage in the land use is respectively corrected. And precipitation from the meteorological station and precipitation station is spatially arranged to obtain the spatial distribution characteristics of regional precipitation. Based on the types of land use and raster layer, the types of water sources of slopes and river systems are further classified. The pastures are classified as winter pasture, summer pasture, wetland pasture, glacier pasture etc. according to the results of hydrogeological exploration and ground observation. The water sources classification system of the artificial ecosystem is constructed further based on the survey of urban water sources.

The indicators are introduced to figure out the correlation of vegetation-moisture-energy of sloping system with respect to the mechanism analysis. Based on the topography factors (i.e. topographic relief amplitude, slope gradient, slope aspect, vegetation coverage, precipitation, etc.), the water source zoning indicator system for the sloping system is established. The lake layer is extracted from the type of land use, and is corrected according to river system and water conservancy explorations, considering the vegetation coverage and precipitation factors, the indicator system of water sources of lake is established. The catchment area and water system are formed according to the digital elevation model, and the indicator system of water sources of the main controlling transect is then constructed with further reference to the precipitations of the main control transects of mainstream and 1-level tributaries , the vegetation coverage, and the process of runoff and flow concentration. And based on the types of water sources and the created indicator thereof, a spatial distribution map for the types of water sources is provided by spatial cluster analysis.

The disclosed embodiments described above enable those skilled in the art to make or use the present invention. Various modifications to these embodiments would be obvious to those skilled in the art. The generic principles defined herein may be implemented in other embodiments without departing from the spirit or scope of the invention. Accordingly, the present invention is not limited to the embodiments shown herein, but should be consistent with the widest scope of the principles and novel features disclosed herein.

What is claimed is:

1. A method for analyzing types of water source based on natural geographical features, the method comprising:
S1: collecting remote sensing image data of a target area, processing the remote sensing image data, and obtaining a maximum value and a minimum value of an annual vegetation index;
S2: subtracting the minimum value from the maximum value of the annual vegetation index to obtain a maximum variation range of the annual vegetation index;
S3: extracting topography factors correlated to a landform classification from digital elevation model data in the target area;
S4: obtaining a natural vegetation area in the target area;
S5: carrying out a normalization processing for the maximum variation range of the annual vegetation index and the topography factors in the natural vegetation area, obtaining landform zones and a situation of plant growth of different zones in the natural vegetation area by technologies of an ArcGIS spatial cluster analysis and a spatial analysis,;
S6: obtaining a precipitation of the landform zones in a growing season and a distance between the landform zones and the water sources;
S7: analyzing types of water supplies of the zones with reference to the precipitation of landform zones in the growing season and the distance between the landform zones and the water sources, obtaining the zones for the types of water sources based on the natural geographical features.

2. The method for analyzing types of water source based on natural geographical features of claim 1 wherein, in the step S1, the remote sensing image data of the target area is collected by a moderate-resolution imaging spectroradiometer.

3. The method for analyzing types of water source based on natural geographical features of claim 1 wherein the step S1 includes
S11: processing the remote sensing image data by a remote sensing image processing and a Python program, interpreting a processing result quantitatively to obtain a target area layer with information of a vegetation index;
S12: obtaining the maximum value and minimum value of the annual vegetation index using a raster calculator in an ArcGIS in a combination with the Python program.

4. The method for analyzing types of water source based on natural geographical features of claim 1 wherein the step S3 includes
S31: with digital elevation model data used as a data source, resampling in an ArcGIS, obtaining a raster data with a same data projection and resolution as the vegetation index;
S32: generating a raster layer of topography factors according to the digital elevation model by using a Spatial Analysis tool in the ArcGIS.

5. The method for analyzing types of water source based on natural geographical features of claim 1 wherein the topography factors include a slope gradient and a topographic relief amplitude.

6. The method for analyzing types of water source based on natural geographical features of claim 1 wherein the step S4 is includes analyzing a land use map of the target area in ArcGIS, obtaining the natural vegetation area in the target area with different types of land forms including a permanent glacier and a snow field, a canal, a lake, an urban land, rural resident area, a sandy land, a Gobi, a bare land, and a bare rock and gravel land removed.

7. The method for analyzing types of water source based on natural geographical features of claim 1 wherein in the step S5, when the normalization processing is employed to process the vegetation index and raster layer of the topography factors of the natural vegetation area by a linear function, a raster value is mapped within a range of 0-1, a conversion formula of the linear function is:
$$Y = \frac{X - {X}_{min}}{{X}_{max} - {X}_{min}}$$
where X indicates a raster value before the conversion, Xₘₐₓ indicates a maximum raster value in a certain clustering factor raster layer within the target area; Xₘᵢₙ indicates a minimum raster value in a certain clustering factor raster layer within the target area; Y indicates a converted raster value.

8. The method for analyzing types of water source based on natural geographical features of claim 1 wherein the step S6 includes with TRMM data in the landform zones used as a data source, resampling in a ArcGIS, obtaining raster data with a same data projection and resolution of the vegetation index and having a temporal resolution of one-day; obtaining the raster data of the precipitation of the landform zones in the growing season by the technologies of the ArcGIS and a Python.

9. The method for analyzing types of water source based on natural geographical features of claim 1 wherein in the step S7, analyzing the types of water supplies in the zones, with reference to a multi-year average precipitations of the landform zones in the growing season and distances between the landform zones and rivers, lake, glaciers etc.,
wherein a region that has a higher altitude, a better plant growth, and is more close to glaciers is zoned as a supply of glacier glacial snowmelt water and precipitation; a region that is farther from the water sources, has a smaller topographic relief amplitude and a lowered altitude is zoned as a supply of groundwater; a region that has more precipitations in the growing season is zoned as a supply of precipitation.

10. The method for analyzing types of water source based on natural geographical features of claim 9 wherein the step S7 includes with reference to an analysis of topography and hydrology, classifying types of the water supplies of the landform zones as: a supply by the glacial snowmelt water, a supply by precipitation, a supply by precipitation and soil water, a supply by precipitation and groundwater outcropping, a supply by flood, groundwater lateral seepage and precipitation, a supply by precipitation, soil water and groundwater outcropping;
obtaining the zones for the types of the water sources based on the natural geographical features by providing a spatial distribution map for the types of water sources according to the types of water supplies.

11. The method for analyzing types of water source based on natural geographical features of claim 2 wherein the step S1 includes
S11: processing the remote sensing image data by a remote sensing image processing and a Python program, interpreting the processing result quantitatively to obtain a target area layer with information of a vegetation index;
S12: obtaining the maximum value and minimum value of the annual vegetation coverage index using a raster calculator in an ArcGIS in a combination with the Python program.

12. The method for analyzing types of water source based on natural geographical features of claim 4 wherein the topography factors include a slope gradient and a topographic relief amplitude.

13. The method for analyzing types of water source based on natural geographical features of claim 4 wherein the step S4 includes
analyzing a land use map of the target area in an ArcGIS, obtaining the natural vegetation area in the target area with the different types of land forms including a permanent glacier and a snow field, a canal, a lake, an urban land, rural resident area, a sandy land, a Gobi, a bare land, and a bare rock and gravel land removed.

14. The method for analyzing types of water source based on natural geographical features of claim 7 wherein the step S6 includes
with TRMM data in the landform zones used as a data source, resampling in an ArcGIS, obtaining raster data with a same data projection and resolution of the vegetation index and having a temporal resolution of one-day; obtaining the raster data of the precipitation of the landform zones in the growing season by combining technologies of ArcGIS and a Python program.
